(19) United States
(12) Patent Application Publication
(10) Pub. No.: US 2023/0236308 A1
(43) Pub. Date: Jul. 27, 2023

(54) COMMUNICATION APPARATUS AND DISTANCE GENERATION METHOD THEREOF

(71) Applicant: Sony Semiconductor Solutions Corporation, Kanagawa (JP)

(72) Inventors: Hiroaki Nakano, Tokyo (JP); Toru Terashima, Kanagawa (JP); Takuya Ichihara, Tokyo (JP)

(21) Appl. No.: 18/009,200

(22) PCT Filed: Mar. 18, 2021
(86) PCT No.: PCT/JP2021/011131

§ 371 Date: Dec. 8, 2022

(30) Foreign Application Priority Data
Jun. 16, 2020 (JP) 2020-103467

(51) Int. Cl. G01S 13/84; G01S 13/36

(52) U.S. Cl. CPC G01S 13/84; G01S 13/36

(57) ABSTRACT

When measuring a distance between communication apparatuses, influence by a frequency offset between communication apparatuses is suppressed.

A communication apparatus includes a frequency offset acquisition unit, a time acquisition unit, a phase acquisition unit, and a distance generation unit. The frequency offset acquisition unit acquires a frequency offset between frequencies used for transmission/reception by respective ones of the communication apparatuses. The time acquisition unit acquires transmission/reception time between the communication apparatuses. The phase acquisition unit acquires a phase relationship between frequencies used for transmission/reception. The distance generation unit generates distance information on the basis of the phase relationship.

### TECHNICAL FIELD

The present technique relates to a communication apparatus. Specifically, the present technique relates to a communication apparatus that generates distance information between communication apparatuses and a distance generation method thereof.

### BACKGROUND ART

In recent years, with the spread of map applications and the like based on a global positioning system (GPS), indoor positioning technologies have attracted attention. Since radio waves from satellites do not reach indoors and GPS cannot be used, various methods have been proposed. Such methods include, for examples, a pedestrian dead reckoning (PDR) method that measures motions and the amount of movement of a user by a plurality of sensors such as an acceleration sensor and a gyro sensor, a method of estimating a position by collation of geomagnetic data, a method of estimating a distance from a wavelength by using the time difference between a light projection wave and a reflected wave of light (time of flight (ToF)), and a ranging method by using wireless signals. For example, as a ranging method by using wireless signals, a technique has been proposed in which the phase rotation amount between ranging signals of two communication apparatuses is obtained for each frequency to estimate a distance between the communication apparatuses (see, for example, Patent Document 1).

### CITATION LIST

### Patent Document

Patent Document 1: Japanese Patent Application Laid-Open No. 2018-124181

### SUMMARY OF THE INVENTION

### Problems to be Solved by the Invention

In the above-described conventional technique, since the slope in the relationship between the frequency and the phase rotation amount indicates the delay time of a ranging signal, a propagation distance is calculated by multiplying the delay time by a known speed of light to estimate the distance between communication apparatuses. In this conventional technique, round-trip communication is performed to cancel a difference in local phase between the communication apparatuses. However, in a case where there is a frequency offset between local oscillators of both of the communication apparatuses, the difference in local phase cannot be canceled, so that ranging accuracy may be greatly reduced.

The present technique has been developed in view of such situation, and an object thereof is to suppress influence by the frequency offset between communication apparatuses when measuring the distance therebetween.

### Solutions to Problems

The present technique has been developed to solve the above-described issue, and a first aspect of the present technique is a communication apparatus and a distance generation method thereof. The communication apparatus includes a frequency offset acquisition unit that acquires a frequency offset between frequencies used for transmission/reception by respective communication apparatuses, a time acquisition unit that acquires transmission/reception time between the communication apparatuses, a phase acquisition unit that acquires a phase relationship between the frequencies used for the transmission/reception, and a distance generation unit that generates distance information on the basis of the phase relationship. This provides an effect that distance information is generated on the basis of a phase relationship between frequencies used for transmission/reception.

Furthermore, in the aspect, the phase acquisition unit may acquire the phase relationship on the basis of the frequency offset and the transmission/reception time. This provides an effect that distance information is generated on the basis of the phase relationship acquired on the basis of the frequency offset and the transmission/reception time.

Furthermore, in the first aspect, the distance generation unit may generate the distance information on the basis of group delay information generated from the phase relationship. This provides an effect that distance information is generated on the basis of group delay information.

Furthermore, in the first aspect, the phase acquisition unit may correct, on the basis of the frequency offset, the phase relationship obtained from the transmission/reception time. In this case, the distance generation unit may generate the distance information on the basis of the phase relationship that has been corrected.

Furthermore, in the first aspect, the frequency offset acquisition unit may measure the frequency offset in first communication, and the time acquisition unit may measure the transmission/reception time in second communication that is performed after the first communication. This provides an effect that a frequency offset is measured prior to measurement of transmission/reception time.

Furthermore, in the first aspect, the frequency offset acquisition unit may measure the frequency offset on the basis of change, in a certain period, of amplitudes of projections of a signal on an I axis and a Q axis, the signal having been transmitted/received between the communication apparatuses and IQ modulated.

Furthermore, in the first aspect, the frequency offset acquisition unit may measure the frequency offset on the basis of a signal obtained by performing fast Fourier transform on a signal received between the communication apparatuses.

Furthermore, in the first aspect, the time acquisition unit may acquire the transmission/reception time by measuring a period from a transmission timing of a signal to reception of a known pattern in response to the signal between the communication apparatuses.

Furthermore, in the first aspect, the communication apparatus may further include a frequency generation unit that generates a frequency used for transmission/reception between the communication apparatuses, and the frequency offset acquisition unit may measure the frequency offset between the frequencies used by respective ones of the communication apparatuses.

### BRIEF DESCRIPTION OF DRAWINGS

FIG. 1 is a diagram illustrating a configuration example of a communication apparatus according to an embodiment of the present technique.

FIG. 2 is a diagram illustrating an exemplary aspect of distance measurement according to the embodiment of the present technique.

FIG. 3 is a diagram illustrating an example of a signal phase of communication from an initiator 10 to a reflector 20 according to the embodiment of the present technique.

FIG. 4 is a diagram illustrating an example of a signal phase of communication from the reflector 20 to the initiator 10 according to the embodiment of the present technique.

FIG. 5 is a diagram illustrating an exemplary aspect of time measurement timing according to the embodiment of the present technique.

FIG. 6 is a diagram illustrating a packet configuration example of a measurement signal according to the embodiment of the present technique.

FIG. 7 is a diagram illustrating an example of a relationship between signals of the I channel and the Q channel and a frequency offset according to the embodiment of the present technique.

FIG. 8 is a diagram illustrating an example of correlation between signals of the I channel and the Q channel and a known pattern according to the embodiment of the present technique.

FIG. 9 is a diagram illustrating an example of a phase waveform according to the embodiment of the present technique.

FIG. 10 is a diagram illustrating an example of a relationship between a frequency distribution of a signal and a frequency offset according to the embodiment of the present technique.

FIG. 11 is a diagram illustrating an example in which distance information is generated from a phase relationship in a distance generation unit 116 according to the embodiment of the present technique.

FIG. 12 is a flowchart illustrating an example of a measurement procedure performed between the initiator 10 and the reflector 20 according to the embodiment of the present technique.

FIG. 13 is a sequence diagram illustrating an example of a measurement procedure performed between the initiator 10 and the reflector 20 according to the embodiment of the present technique.

FIG. 14 is a diagram illustrating a communication system that is an application example of the embodiment of the present technique.

### MODE FOR CARRYING OUT THE INVENTION

A mode for carrying out the present technique (hereinafter, referred to as an embodiment) will be described below. The description will be given in the following order.

1. Embodiment

2. Application Example

### 1. EMBODIMENT

### Communication Apparatus

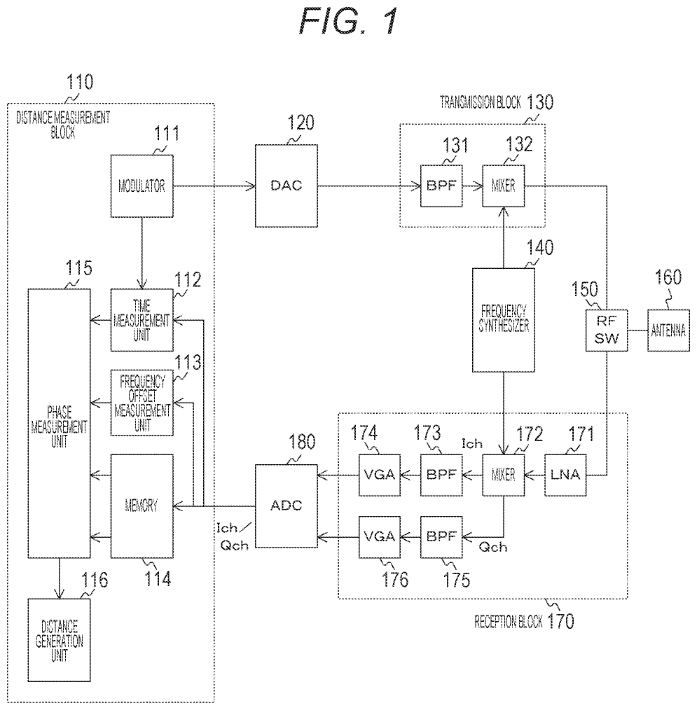

FIG. 1 is a diagram illustrating a configuration example of a communication apparatus according to an embodiment of the present technique.

The communication apparatus includes a distance measurement block 110, a DAC 120, a transmission block 130, a frequency synthesizer 140, an RF switch 150, an antenna 160, a reception block 170, and an ADC 180. The distance measurement block 110 is a block that measures a distance to another communication apparatus. The distance measurement block 110 includes a modulator 111, a time measurement unit 112, a frequency offset measurement unit 113, a memory 114, a phase measurement unit 115, and a distance generation unit 116.

The modulator 111 performs a modulation process of a signal for communication. Hereinafter, performing IQ modulation is assumed as an example of the modulation process. In IQ modulation, signals of the I channel (In-phase: in-phase component) and the Q channel (Quadrature: quadrature component) are used as baseband signals.

The digital-to-analog converter (DAC) 120 converts a digital signal from the modulator 111 into an analog signal. The analog signal converted by the DAC 120 is supplied to the transmission block 130.

The transmission block 130 is a block that transmits a signal by wireless communication. The transmission block 130 includes a BPF 131 and a mixer 132. The band-pass filter (BPF) 131 is a filter that allows passage of only signals within a specific frequency band. The BPF 131 supplies, to the mixer 132, only signals within the specific frequency band in analog signals from the DAC 120. The mixer 132 mixes a signal supplied from the BPF 131 with a local oscillation frequency supplied from the frequency synthesizer 140 to convert the signal to have a transmission frequency for wireless communication.

The frequency synthesizer 140 supplies a frequency used for transmission/reception. The frequency synthesizer 140, as described below, includes a local oscillator therein, and is used for conversion of a radio frequency signal for wireless communication and a baseband signal.

The RF switch 150 is a switch that switches a radio frequency (RF) signal. The RF switch 150 connects the transmission block 130 to the antenna 160 at the time of transmission, and connects the reception block 170 to the antenna 160 at the time of reception. The antenna 160 is an antenna for performing transmission/reception by wireless communication.

The reception block 170 is a block that receives a signal by wireless communication. The reception block 170 includes an LNA 171, a mixer 172, BPFs 173 and 175, and VGAs 174 and 176.

The low noise amplifier (LNA) 171 is an amplifier that amplifies an RF signal received by the antenna 160. The mixer 172 mixes a signal supplied from the LNA 171 with a local oscillation frequency supplied from the frequency synthesizer 140 to convert the signal into signals of the I channel and the Q channel. The signal of the I channel is supplied to the BPF 173, and the signal of the Q channel is supplied to the BPF 175. The BPFs 173 and 175 are filters that allow passage of only signals within a specific frequency band similarly to the BPF 131. Variable gain amplifiers (VGAs) 174 and 176 are analog variable gain amplifiers that adjust gains of signals from the BPFs 173 and 175, respectively.

The analog-to-digital converter (ADC) 180 converts signals of the I channel and the Q channel from the VGAs 174 and 176 from analog signals to digital signals.

The time measurement unit 112 measures the time taken for transmission/reception between the communication apparatuses. The time measurement unit 112 can grasp the transmission timing by using a signal from the modulator 111 and the reception timing by using a signal from the ADC 180. Accordingly, the time measurement unit 112 can measure the transmission/reception time. Note that the time measurement unit 112 is an example of a time acquisition unit described in the claims.

The frequency offset measurement unit 113 measures a frequency offset between frequencies used for transmission/reception by the respective communication apparatuses. When measuring a distance between the communication apparatuses, if frequencies are different between local oscillators of the respective communication apparatuses, the ranging accuracy may be reduced as described later. Thus, the difference in frequency between local oscillators is measured as a frequency offset to improve the ranging accuracy. Note that the frequency offset measurement unit 113 is an example of a frequency offset acquisition unit described in the claims.

The memory 114 is a memory for temporarily holding data of signals of the I channel and the Q channel from the ADC 180.

The phase measurement unit 115 measures a phase relationship between frequencies used for transmission/reception. The phase measurement unit 115 measures the phase relationship between the frequencies on the basis of data of signals of the I channel and the Q channel from the ADC 180. Furthermore, the phase measurement unit 115 corrects the phase relationship between the frequencies on the basis of a frequency offset measured by the frequency offset measurement unit 113 and the time taken for transmission/reception measured by the time measurement unit 112. Accordingly, a more accurate phase relationship can be obtained. Note that the phase measurement unit 115 is an example of a phase acquisition unit described in the claims.

The distance generation unit 116 generates distance information on the basis of the phase relationship between frequencies measured and corrected by the phase measurement unit 115. Since the slope in the relationship between the frequency and the phase rotation amount indicates the delay time of a ranging signal, the distance between the communication apparatuses can be obtained by multiplying the delay time by the speed of light. In this embodiment, by obtaining a more accurate phase relationship, it can be expected that the distance information that is obtained is more accurate.

### Distance Measurement

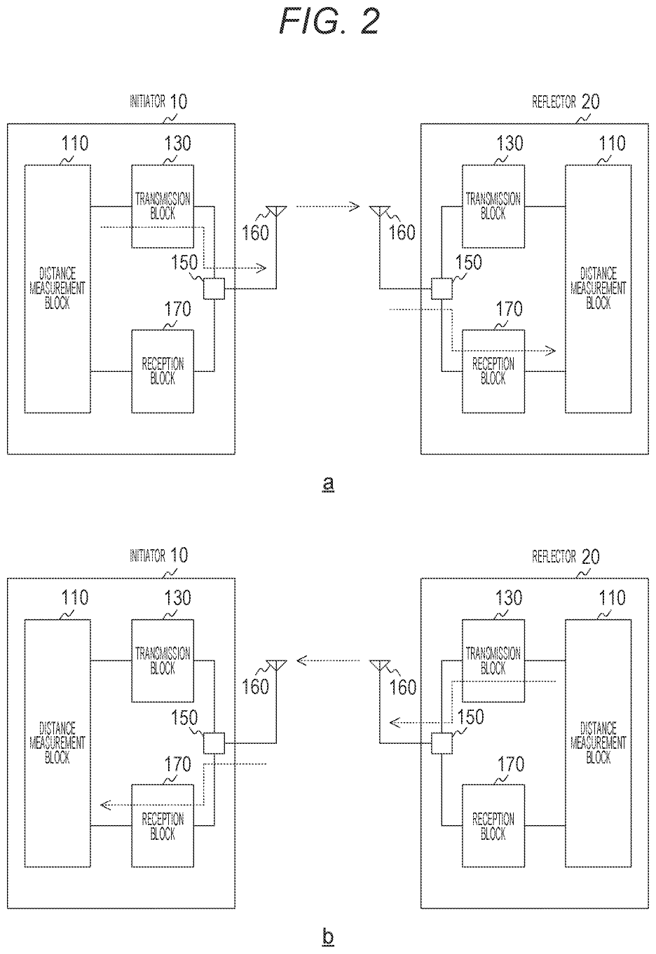

FIG. 2 is a diagram illustrating an exemplary aspect of distance measurement according to the embodiment of the present technique.

When measuring a distance between the communication apparatuses, first, as illustrated in a of the figure, a measurement signal is transmitted from one communication apparatus (initiator 10) to the other communication apparatus (reflector 20). The above-described communication apparatuses can be used as either the initiator 10 or the reflector 20.

In this example, only the main blocks are illustrated. That is, in the initiator 10, the measurement signal from the distance measurement block 110 is transmitted from the antenna 160 through the transmission block 130. Furthermore, in the reflector 20, the measurement signal is received by the reception block 170 through the antenna 160.

Then, as illustrated in b of the figure, a measurement signal is returned from the reflector 20 to the initiator 10. That is, in the reflector 20, the measurement signal from the distance measurement block 110 is transmitted from the antenna 160 through the transmission block 130. Furthermore, in the initiator 10, the measurement signal is received by the reception block 170 through the antenna 160, and the distance between the initiator 10 and the reflector 20 is measured in the distance measurement block 110.

By thus performing the round-trip communication, it is possible to measure a difference between the phases and to measure the distance by using the phases.

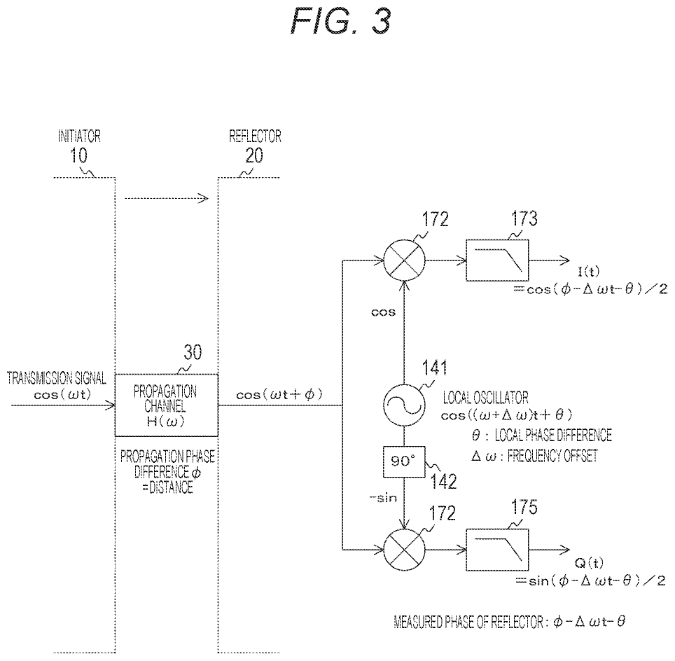

FIG. 3 is a diagram illustrating an example of a signal phase of communication from the initiator 10 to the reflector 20 according to the embodiment of the present technique.

Here, a signal of cos(ωt) is transmitted from the initiator 10, and a phase difference of a propagation channel 30 is defined as φ. That is, φ is a phase value based on a distance to be calculated. A reception signal at the reflector 20 is cos(ωt+φ) having a phase changed by φ.

Then, the mixer 172 down-converts the reception signal cos (ωt+φ) to obtain reception signals of the I channel and the Q channel. Since a local oscillator 141 of the reflector 20 used for this down conversion is not synchronized with that of the initiator 10, there are a local phase difference θ and a frequency offset Δω. That is, a signal from the local oscillator 141 of the reflector 20 is expressed as cos((ω+Δω)t+θ). Note that the local oscillator 141 is an example of a frequency generation unit described in the claims.

A signal of the I channel I(t) is obtained by mixing the reception signal cos(ωt+φ) with cos((ω+Δω)t+θ) of the local oscillator 141.

I(t)=cos(φ−Δωt−θ)/2

On the other hand, a signal of the Q channel Q(t) is obtained by mixing the reception signal cos(ωt+φ) with −sin((ω+Δω)t+θ) obtained by rotating the signal of the local oscillator 141 by 90 degrees by a phase converter 142.

Q(t)=sin(φ−Δωt−θ)/2

By detecting the angle of signals of the I channel and Q channel, the phase of the reflector 20 can be measured. The angle in this case can be calculated by calculating an arctangent of the reception signals of the I channel and the Q channel. That is, the phase obtained on the reflector 20 side is “φ−Δωt−θ”.

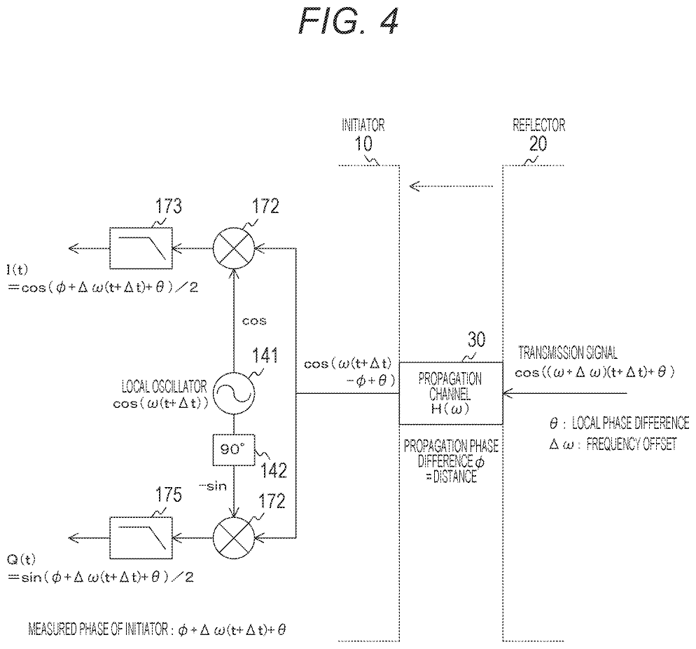

FIG. 4 is a diagram illustrating an example of a signal phase of communication from the reflector 20 to the initiator 10 according to the embodiment of the present technique.

Here, similarly to the communication from the initiator 10 to the reflector 20, a propagation phase difference in the propagation channel 30 is defined as φ, the local phase difference in the local oscillator 141 as θ, and the frequency offset as Δω. Furthermore, a transmission start time difference between the initiator 10 and the reflector 20 is defined as Δt.

A transmission signal from the reflector 20 is expressed as cos((ω+Δω) (t+Δt)+θ). Then, a reception signal at the initiator 10 is cos(ω(t+Δt)−φ+θ).

Then, the mixer 172 down-converts the reception signal cos(ω(t+Δt)−φ+θ) to obtain reception signals of the I channel and the Q channel. The local oscillator 141 of the initiator 10 used for this down conversion is expressed as cos(ω(t+Δt)).

A signal of the I channel I(t) is obtained by mixing the reception signal cos(ω(t+Δt)−φ+θ) with cos(ω(t+Δt)) of the local oscillator 141.

I(t)=cos(φ+Δω(t+Δt)+θ)/2

On the other hand, a signal of the Q channel Q(t) is obtained by mixing the reception signal cos(ω(t+Δt)−φ+θ) with −sin(ω(t+Δt)) obtained by rotating the signal of the local oscillator 141 by 90 degrees by the phase converter 142.

Q(t)=sin(φ+Δω(t+Δt)+θ)/2

Thus, the phase obtained on the initiator 10 side is “φ+Δω(t+Δt)+θ”.

By adding the phase on the reflector 20 side to the phase on the initiator 10 side obtained in this manner, the following equation is obtained.

(φ−Δωt−θ)+(φ+Δω(t+Δt)+θ)=2φ+Δω×Δt

That is, it can be seen that the phase for calculating a distance does not contain the local phase θ since it is canceled, but contains the product of the component of the frequency offset Δω and the transmission start time difference Δt. Thus, these components may be a factor for reducing the ranging accuracy.

Ideally, it is desirable that influence on the ranging accuracy can be suppressed by making the frequency offset Δω and the transmission start time difference Δt to as close to zero as possible, but making these values to zero is actually difficult. Thus, in this embodiment, the frequency offset measurement unit 113 measures the frequency offset Δω in wireless communication between the initiator 10 and the reflector 20. Furthermore, the time measurement unit 112 measures the transmission start time difference Δt in wireless communication between the initiator 10 and the reflector 20. Then, the phase measurement unit 115 corrects the phase relationship by subtracting Δω×Δt from the phase relationship calculated by round-trip communication. Accordingly, the accuracy of the distance information obtained from the phase relationship is improved.

### Transmission Start Time Difference

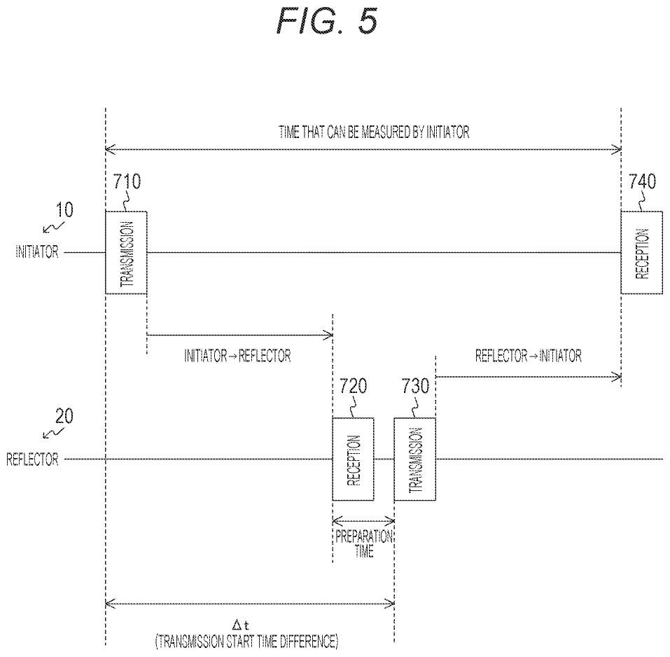

FIG. 5 is a diagram illustrating an exemplary aspect of time measurement timing according to the embodiment of the present technique.

As described above, in the embodiment, a phase relationship is measured by transmitting/receiving measurement signals by round-trip communication between the initiator 10 and the reflector 20, and distance information is generated on the basis of the phase relationship.

First, the initiator 10 performs a transmission process 710 of a measurement signal to the reflector 20. Accordingly, the measurement signal is transmitted from the initiator 10 to the reflector 20 by wireless communication via the propagation channel 30.

Next, the reflector 20 performs a reception process 720 of the measurement signal from the initiator 10. Then, in response to the received measurement signal, after a predetermined preparation time, the reflector 20 starts a transmission process 730 of a measurement signal to the initiator 10. Accordingly, the measurement signal is transmitted from the reflector 20 to the initiator 10 by wireless communication via the propagation channel 30.

The initiator 10 performs a reception process 740 of the measurement signal from the reflector 20. As a result, the initiator 10 can measure the time that has been taken for the round-trip communication from the difference between the start timing of the transmission process 710 and the start timing of the reception process 740. The time that has been taken for the round-trip communication includes, addition to the propagation time during which the measurement signals propagate through the propagation channel 30, the transmission time taken for the transmission processes 710 and 730 and the preparation time taken from the start of the reception process 720 to the start of the transmission process 730.

On the other hand, the transmission start time difference Δt necessary for correcting the phase relationship is a difference between the start timing of the transmission process 710 and the start timing of the transmission process 730 as illustrated in the figure. Thus, if the initiator 10 grasps the transmission time taken for the transmission processes 710 and 730 and the preparation time taken from the start of the reception process 720 to the start of the transmission process 730, the initiator 10 can exclude these from the measurement time of the round-trip communication and calculate a half value thereof to obtain the one-way propagation time in which the measurement signals have propagated through the propagation channel 30. Then, by adding, to the value, the transmission time for the transmission process 710 and the preparation time until the transmission process 730, the transmission start time difference Δt can be obtained. Here, regarding the preparation time until the transmission process 730, the value measured by the reflector 20 may be transmitted to the initiator 10, or the preparation time may be ignored in the case where it is sufficiently smaller than the propagation time. Furthermore, regarding the transmission time of the transmission processes 710 and 730, the values measured by the initiator 10 and the reflector 20, respectively, may be used, or known values may be used, and alternatively, the transmission time may be ignored in the case where it is sufficiently smaller than the propagation time.

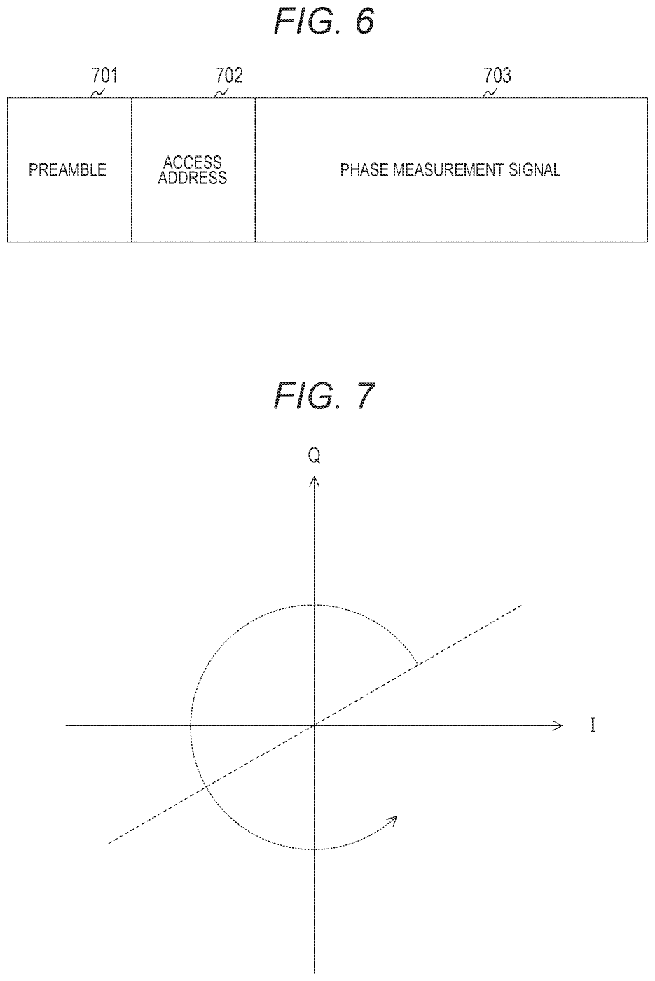

FIG. 6 is a diagram illustrating a packet configuration example of a measurement signal according to the embodiment of the present technique.

This measurement packet includes fields of a preamble 701, an access address 702, and a phase measurement signal 703. The preamble 701 is a field added to the top of this packet. The access address 702 is a field indicating a destination address of this packet. The phase measurement signal 703 is a field including a signal for phase measurement.

In the above example, the time difference between the heads of the measurement signals is assumed as the transmission start time difference Δt, but other timings may be used. For example, a known pattern may be provided in the preamble 701 or the access address 702, and the positions thereof may be compared to obtain the transmission start time difference Δt. Furthermore, a known pattern may be arranged at a specific position such as the head of the phase measurement signal 703, and the positions may be compared to obtain the transmission start time difference Δt.

### Frequency Offset

FIG. 7 is a diagram illustrating an example of a relationship between signals of the I channel and the Q channel and a frequency offset according to the embodiment of the present technique.

There are various methods for measuring a frequency offset. A method for measuring a frequency offset on the basis of signal balance of the I channel and the Q channel will be described below. In a case where there is a frequency offset between communication apparatuses, the signal balance of the I channel and the Q channel changes to rotate with time. The larger the frequency offset is, the faster this rotational speed becomes. Since this value needs to be detected, a known pattern is output at regular intervals, and the angle is detected from the amplitude values of the I axis and the Q axis. This process performed for a certain period, and the angle rotated with in the certain period (angular velocity) is the frequency offset (rad/s).

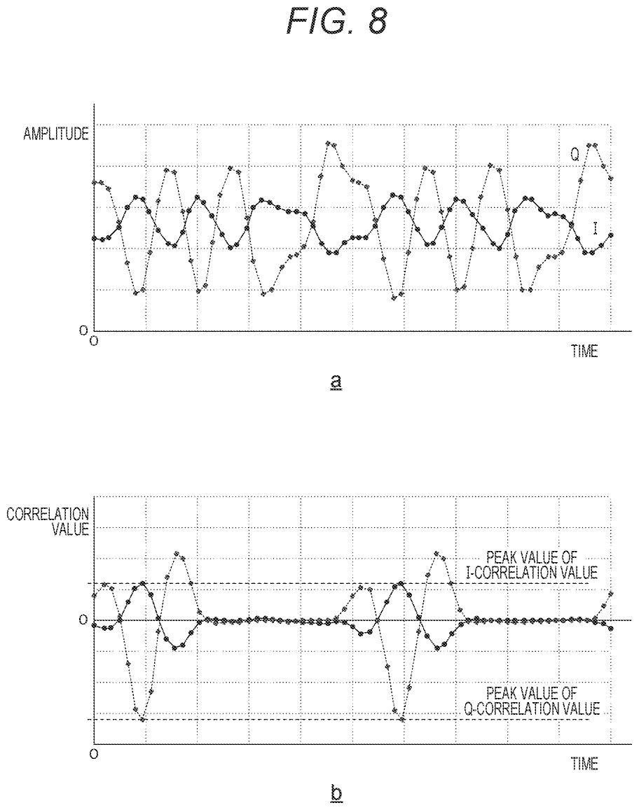

FIG. 8 is a diagram illustrating an example of correlation between signals of the I channel and the Q channel and a known pattern according to the embodiment of the present technique.

As illustrated in a of the figure, each signal of the I channel and the Q channel changes with time. Note that, in the figure, the I channel signal is indicated by a solid line, and the Q channel signal is indicated by a dotted line.

At this time, correlation values of the waveforms of the signals of the I channel and the Q channel and waveforms of a known pattern are illustrated as in b of the figure. That is, each of the peak value of the correlation value of the signal of the I channel and the peak value of the correlation value of the signal of the Q channel is obtained. Since this example is illustrated in a short period, change in the peak values is not remarkable, but in practice, the peak values change with time.

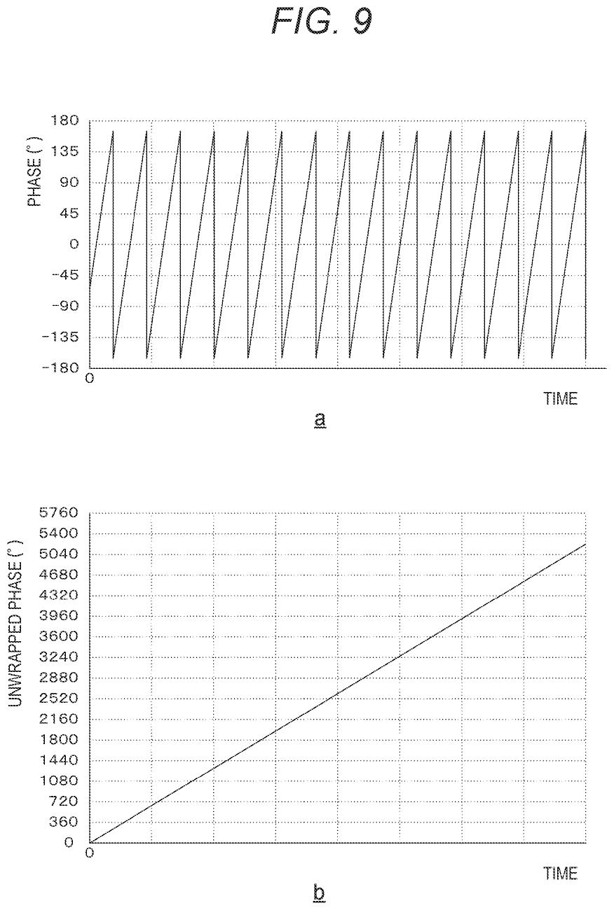

FIG. 9 is a diagram illustrating an example of a phase waveform according to the embodiment of the present technique.

When the above-described peak values of the correlation values of the signals of the I channel and the Q channel are converted by the arctangent function (arctangent), the graph illustrated in a of the figure is obtained. Note that the range of the horizontal axis is greatly expanded in the figure to view change in long time in amplitude balance of the signals of the I channel and the Q channel.

Then, when an unwrapping process is performed so as not to turn the graph illustrated in a of the figure at every 360 degrees, the graph illustrated as b in the figure is obtained. In the waveform after the unwrapping process, if there is no frequency offset, the slope is zero and is a horizontally straight line, but if there is a frequency offset, this slope indicates the frequency offset.

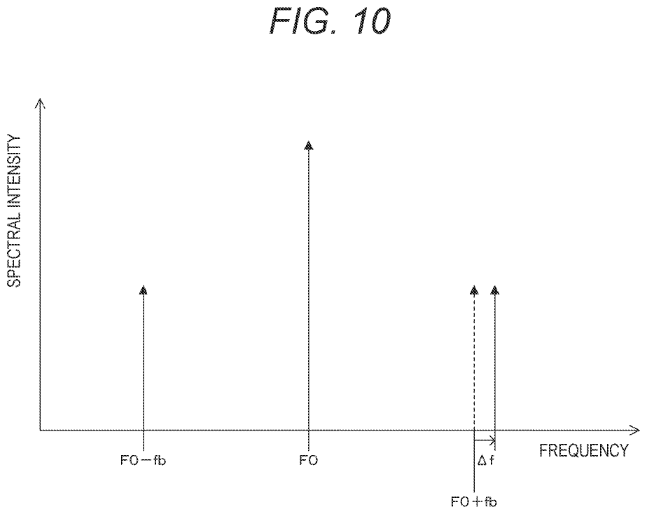

FIG. 10 is a diagram illustrating an example of a relationship between a frequency distribution of a signal and a frequency offset according to the embodiment of the present technique.

In the above example, the method of measuring a frequency offset on the basis of the signal balance of the I channel and the Q channel has been described, but as another method, a frequency offset can be measured by performing fast Fourier transform (FFT) on a reception signal.

For example, when a modulated signal by, such as, binary phase shift keying (BPSK) is subjected to fast Fourier transform, a spectrum of the baseband signal appears on the positive side and the negative side with respect to the peak signal F0 on the frequency axis. In a case of no frequency offset, it is a signal shifted by the frequency of the baseband signal, but if there is a frequency offset, the value is further shifted by the frequency offset. Since a frequency fb of the baseband signal is usually known, Δf, that is, the frequency offset can be calculated by the signal after the fast Fourier transform.

### Generation of Distance Information

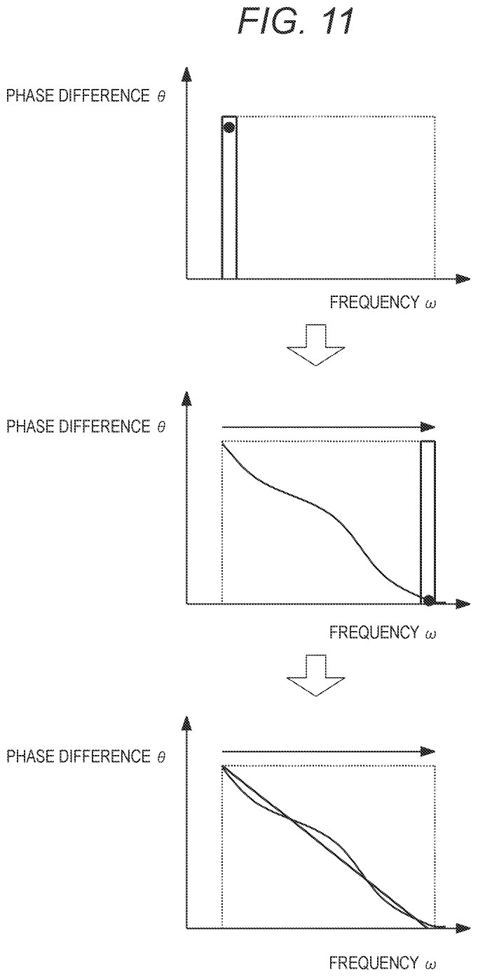

FIG. 11 is a diagram illustrating an example in which distance information is generated from the phase relationship in the distance generation unit 116 according to the embodiment of the present technique.

As illustrated in the figure, when the horizontal axis represents a frequency ω and the vertical axis represents a phase difference θ, the phase difference θ changes substantially linearly with respect to the frequency. A group delay τ can be calculated from the slope of the phase difference. The group delay τ is obtained by differentiating the phase difference θ between an input waveform and an output waveform with respect to the angular frequency ω. Since a phase cannot be distinguished from a phase shifted by an integral-multiple of 2π, the group delay is used as an index indicating a characteristic of a filter circuit.

When a phase difference between a transmission signal and a reception signal is defined as θd, a measured phase as θm, a distance of the propagation channel 30 as D, and the speed of light as c (=299792458 m/s), the following equation holds.

θd (=θm+2πn)=ωtd=ω×2D/c

When both sides of the above equation are differentiated with respect to the angular frequency ω, the following equation is obtained.

dθd/dω=dθm/dω=2D/c

When the above equation is transformed, the distance D is obtained by the following equation.

D=(c/2)×(dθm/dω)

Thus, when the phase is measured and its slope (differential value with respect to the angular frequency ω) is determined as described above, distance information can be generated on the basis of the phase information.

### Operation

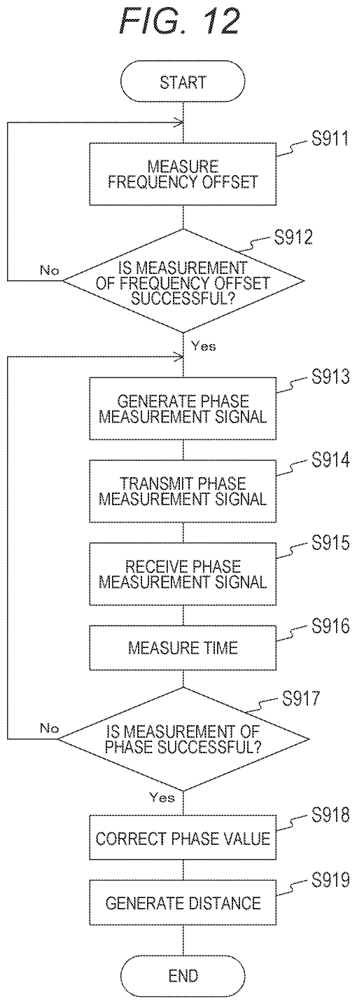

FIG. 12 is a flowchart illustrating an example of a measurement procedure performed between the initiator 10 and the reflector 20 according to the embodiment of the present technique.

The initiator 10 transmits a frequency offset measurement signal to the reflector 20, and measures the frequency offset Δω (step S911). As described above, there are various methods for measuring the frequency offset Δω.

When the measurement of the frequency offset is successful (step S912: Yes), then, the initiator 10 generates a phase measurement signal (step S913) and transmits the signal to the reflector 20 (step S914). Then, the initiator 10 receives a phase measurement signal from the reflector 20 (step S915). Accordingly, as described above, the initiator 10 measures the phase by detecting the angle of the signals of the I channel and the Q channel, and the transmission start time difference Δt (step S916).

When the measurement of the phase is successful (step S917: Yes), the initiator 10 corrects the phase by using the frequency offset Δω and the transmission start time difference Δt that have been measured as described above (step S918). Then, the initiator 10 generates a distance from the corrected phase (step S919).

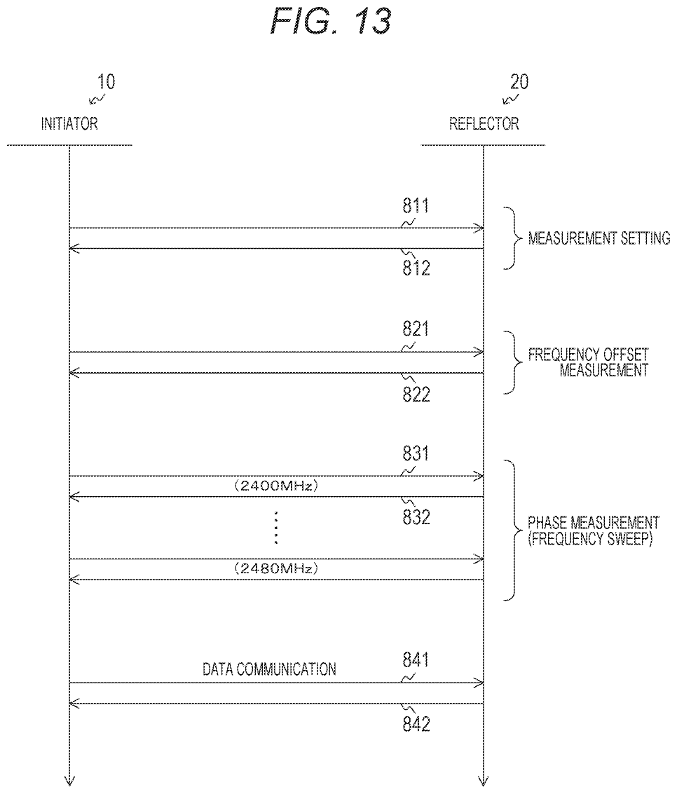

FIG. 13 is a sequence diagram illustrating an example of a measurement procedure performed between the initiator 10 and the reflector 20 according to the embodiment of the present technique.

First, prior to measurement, measurement setting 811 and 812 is performed between the initiator 10 and the reflector 20. In the measurement setting, device authentication, negotiation, and the like are performed.

Then, frequency offset Δω measurement 821 and 822 is performed. In the frequency offset measurement, the measurement target is not limited to only one frequency. For example, since the frequency characteristic may change depending on the surrounding environment or the like, and the measurement target may correspond to a frequency at which it is difficult to receive signals. Thus, it is assumed that measurement is tried at several points, and in a case where the measurement is not successful, measurement is retried with a different frequency, for example.

Then, phase measurement 831 and 832 is performed. In the phase measurement, measurement is performed by sequentially sweeping frequencies in a specific frequency band (for example, 2.4 GHz band) between the initiator 10 and the reflector 20. In addition, after the frequency sweep, data communication 841 and 842 is performed as necessary. As described above, a distance can be generated from the slope of the phase obtained by the phase measurement. Thus, necessary information is exchanged between the initiator 10 and the reflector 20.

As described above, in the embodiment of the present technique, phase information is generated in the phase measurement unit 115 considering the frequency offset Δω measured by the frequency offset measurement unit 113 and the transmission start time difference Δt measured by the time measurement unit 112. Accordingly, the accuracy of the phase information can be improved, and the accuracy of the distance information generated by the distance generation unit 116 can be improved.

### 2. APPLICATION EXAMPLE

In the above-described embodiment, it is assumed that distance information is generated in the distance measurement block 110 of the initiator 10, but the present technique is applicable to various aspects as exemplified below.

### Communication System

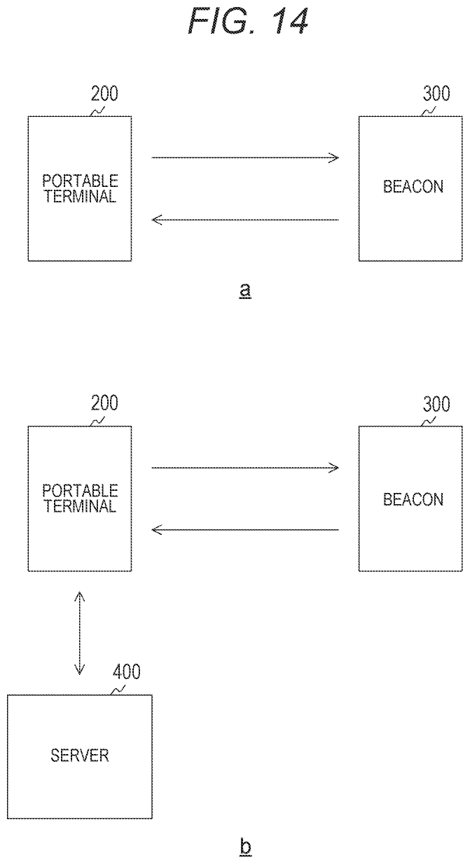

FIG. 14 is a diagram illustrating a communication system that is an application example of the embodiment of the present technique.

In a of the figure, a portable terminal 200 is assumed as a specific example of the communication apparatus according to the embodiment of the present technique. The portable terminal 200 functions as the initiator 10. In addition, it is assumed that a beacon 300 functions as the reflector 20. In this example, a measurement signal is transmitted from the portable terminal 200 to measure the phase relationship, the frequency offset Δω, and the transmission start time difference Δt from the beacon 300. Then, the portable terminal 200 generates distance information on the basis of these pieces of information. Note that the relationship between the portable terminal 200 and the beacon 300 may be reversed. In such case, the beacon 300 may be assumed as a specific example of the communication apparatus according to the embodiment of the present technique.

In b of the figure, a server 400 is assumed as a specific example of the communication apparatus according to the embodiment of the present technique. Also in this case, the portable terminal 200 functions as the initiator 10, and the beacon 300 functions as the reflector 20. Then, the server 400 acquires, from the portable terminal 200, the phase relationship, the frequency offset Δω, and the transmission start time difference Δt between the portable terminal 200 and the beacon 300. Then, the server 400 generates distance information between the portable terminal 200 and the beacon 300 on the basis of these pieces of information that have been acquired. Note that the relationship between the portable terminal 200 and the beacon 300 may be reversed. Furthermore, here, the server 400 is exemplified as a third party that generates the distance information between the portable terminal 200 and the beacon 300, but another portable terminal or the like may generate the distance information as a third party.

Note that the above-described embodiment illustrates an example for embodying the present technique, and the matters in the embodiment and the matters specifying the invention in the claims have a corresponding relationship. Similarly, the matters specifying the invention in the claims and the matters in the embodiment of the present technique assigned the same names as the ones of the matters specifying the invention have a correspondence relationship. However, the present technique is not limited to the embodiment, and can be embodied by making various modifications to the embodiment without departing from the gist thereof.

Furthermore, the processing procedure described in the above-described embodiment may be regarded as a method including the series of procedures, and may be regarded as a program for causing a computer to execute the series of procedures or a recording medium storing the program. As this recording medium, for example, a compact disc (CD), a mini disc (MD), a digital versatile disc (DVD), a memory card, a Blu-ray (registered trademark) disc, or the like can be used.

Note that the effects described in the description are just an example and effects are not limited thereto, and other effects may be exerted.

Note that the present technique can also have the following configurations.

(1) A communication apparatus including
a frequency offset acquisition unit that acquires frequency offsets between frequencies used for transmission/reception by respective communication apparatuses,
a time acquisition unit that acquires transmission/reception time between the communication apparatuses,
a phase acquisition unit that acquires a phase relationship between frequencies used for the transmission/reception, and
a distance generation unit that generates distance information on the basis of the phase relationship.

(2) The communication apparatus according to (1),
in which the phase acquisition unit acquires the phase relationship on the basis of the frequency offset and the transmission/reception time.

(3) The communication apparatus according to (2),
in which the distance generation unit generates the distance information on the basis of group delay information generated from the phase relationship.

(4) The communication apparatus according to (2) or (3),
in which the phase acquisition unit corrects, on the basis of the frequency offset, the phase relationship obtained from the transmission/reception time.

(5) The communication apparatus according to (4),
in which the distance generation unit generates the distance information on the basis of the phase relationship that has been corrected.

(6) The communication apparatus according to any one of (2) to (5),
in which the frequency offset acquisition unit measures the frequency offset in first communication, and
the time acquisition unit measures the transmission/reception time in second communication that is performed after the first communication.

(7) The communication apparatus according to any one of (2) to (6),
in which the frequency offset acquisition unit measures the frequency offset on the basis of change, in a certain period, of amplitudes of projections of a signal on an I axis and a Q axis, the signal having been transmitted/received between the communication apparatuses and IQ modulated.

(8) The communication apparatus according to any one of (2) to (6),
in which the frequency offset acquisition unit measures the frequency offset on the basis of a signal obtained by performing fast Fourier transform on a signal received between the communication apparatuses.

(9) The communication apparatus according to any one of (2) to (8),
in which the time acquisition unit acquires the transmission/reception time by measuring a period from a transmission timing of a signal to reception or a known pattern in response to the signal between the communication apparatuses.

(10) The communication apparatus according to any one of (2) to (9), further including
a frequency generation unit that generates a frequency used for transmission/reception between the communication apparatuses,
in which the frequency offset acquisition unit measures the frequency offset between the frequencies used by respective ones of the communication apparatuses.

(11) A distance generation method of a communication apparatus, the distance generation method including
a procedure of acquiring, by a frequency offset acquisition unit, a frequency offset between frequencies used for transmission/reception by respective communication apparatuses,
a procedure of acquiring, by a time acquisition unit, a transmission/reception time between the communication apparatuses,
a procedure of acquiring, by a phase acquisition unit, a phase relationship between frequencies used for the transmission/reception, and
a procedure of generating, by a distance generation unit, distance information on the basis of the phase relationship.

### REFERENCE SIGNS LIST

10 Initiator

20 Reflector

30 Propagation channel

110 Distance measurement block

111 Modulator

112 Time measurement unit

113 Frequency offset measurement unit

114 Memory

115 Phase measurement unit

116 Distance generation unit

130 Transmission block

132 Mixer

140 Frequency synthesizer

141 Local oscillator

142 Phase converter

150 RF switch

160 Antenna

170 Reception block

172 Mixer

200 Portable terminal

300 Beacon

400 Server

1. A communication apparatus comprising:
a frequency offset acquisition unit that acquires a frequency offset between frequencies used for transmission/reception by respective communication apparatuses;
a time acquisition unit that acquires transmission/reception time between the communication apparatuses;
a phase acquisition unit that acquires a phase relationship between the frequencies used for the transmission/reception; and
a distance generation unit that generates distance information on a basis of the phase relationship.

2. The communication apparatus according to claim 1,
wherein the phase acquisition unit acquires the phase relationship on a basis of the frequency offset and the transmission/reception time.

3. The communication apparatus according to claim 2,
wherein the distance generation unit generates the distance information on a basis of group delay information generated from the phase relationship.

4. The communication apparatus according to claim 2,
wherein the phase acquisition unit corrects, on a basis of the frequency offset, the phase relationship obtained from the transmission/reception time.

5. The communication apparatus according to claim 4,
wherein the distance generation unit generates the distance information on a basis of the phase relationship that has been corrected.

6. The communication apparatus according to claim 2,
wherein the frequency offset acquisition unit measures the frequency offset in first communication, and
the time acquisition unit measures the transmission/reception time in second communication that is performed after the first communication.

7. The communication apparatus according to claim 2,
wherein the frequency offset acquisition unit measures the frequency offset on a basis of change, in a certain period, of amplitudes of projections of a signal on an I axis and a Q axis, the signal having been transmitted/received between the communication apparatuses and IQ modulated.

8. The communication apparatus according to claim 2,
wherein the frequency offset acquisition unit measures the frequency offset on a basis of a signal obtained by performing fast Fourier transform on a signal received between the communication apparatuses.

9. The communication apparatus according to claim 2,
wherein the time acquisition unit acquires the transmission/reception time by measuring a period from a transmission timing of a signal to reception of a known pattern in response to the signal between the communication apparatuses.

10. The communication apparatus according to claim 2, further comprising
a frequency generation unit that generates a frequency used for transmission/reception between the communication apparatuses,
wherein the frequency offset acquisition unit measures the frequency offset between the frequencies used by respective ones of the communication apparatuses.

11. A distance generation method of a communication apparatus, the distance generation method comprising:
a procedure of acquiring, by a frequency offset acquisition unit, a frequency offset between frequencies used for transmission/reception by respective communication apparatuses;
a procedure of acquiring, by a time acquisition unit, a transmission/reception time between the communication apparatuses;
a procedure of acquiring, by a phase acquisition unit, a phase relationship between frequencies used for the transmission/reception; and
a procedure of generating, by a distance generation unit, distance information on a basis of the phase relationship.
